(19) United States
(12) Patent Application Publication
(10) Pub. No.: US 2015/0024789 A1
(43) Pub. Date: Jan. 22, 2015

(54) AUTOMATED RETRIEVAL OF PHYSICAL LOCATION INFORMATION

(71) Applicants: Aras Bilgen, Istanbul (TR); Dirk Hohndel, Portland, OR (US); Michael Leibowitz, Beaverton, OR (US)

(72) Inventors: Aras Bilgen, Istanbul (TR); Dirk Hohndel, Portland, OR (US); Michael Leibowitz, Beaverton, OR (US)

(21) Appl. No.: 13/977,029

(22) PCT Filed: Jun. 8, 2012
(86) PCT No.: PCT/US12/41707

§ 371 Date: Oct. 1, 2014

(51) Int. Cl. G06F 17/30; H04W 4/02; H04W 4/04

(52) U.S. Cl. CPC G06F 17/30241; H04W 4/043; H04W 4/025
USPC 455/456.6

(57) ABSTRACT

Systems and methods may provide for detecting an event on a mobile platform, and determining a physical location of the mobile platform in response to the event. The event may be one of a time-based trigger that identifies a colloquial name for the physical location and a single-action request from a user interface of the mobile platform. In one example, the time-based trigger is scheduled based on a calendar entry that includes the colloquial name and is created before the mobile platform enters the physical location.

### BACKGROUND

Embodiments generally relate to location based services. More particularly, embodiments relate to the determination of mobile platform locations based colloquial names and/or single-action requests.

Location based services may use the physical location of mobile devices/platforms to provide services to those devices. Conventional approaches to determining device location, however, may call for manual entry of the physical location in the format required by the location based application, wherein such an approach may be inconvenient to the user. Indeed, the precise physical location may not even be known by the user at the time the information is requested by the application.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of a logic architecture according to an embodiment;

FIG. 2 is a flowchart of an example of a method of supporting location based services according to an embodiment;

FIG. 3 is a flowchart of an example of a method of processing a colloquial name request according to an embodiment;

FIG. 4A is a block diagram of an example of a colloquial name implementation according to an embodiment;

FIG. 4B is a block diagram of an example of a single-action request implementation according to an embodiment;

FIG. 5 is a screenshot sequence of an example of an approach to determining a physical location of a mobile platform in response to a single-action request according to an embodiment;

FIG. 6 is a screenshot sequence of an example of an approach of using the physical location of FIG. 5 in a navigation application;

FIG. 7 is a block diagram of an example of a processor according to an embodiment; and

FIG. 8 is a block diagram of an example of a system according to an embodiment.

### DETAILED DESCRIPTION

Turning now to FIG, 1, a logic architecture 10 (10a-10d) is shown in which the logic architecture 10 may be generally incorporated into a mobile platform 12 such as a vehicle, laptop computer, personal digital assistant (PDA), wireless smart phone, media player, imaging device, mobile Internet device (MID), any smart device such as a smart phone, smart tablet and so forth, or any combination thereof. In the illustrated example, an event logic module 10a detects one or more events on the mobile platform 12 and a location logic module 10b uses one or more location providers 14 (e.g., Global Positioning System/GPS sensors, Wi-Fi components, etc.) to determine the physical location of the mobile platform 12 in response to the one or more events.

The physical location may be provided to one or more applications 16 such as a navigation application, appointment/calendaring application, photo editing application, social networking application, and so forth, wherein the applications 16 may execute locally on the mobile platform 12 or on a remote platform. The physical location may also be output via a display device 20, stored to local memory (not shown) of the mobile platform 12, transmitted to an off-platform component via a network controller (not shown), and so forth. The illustrated mobile platform 12 also includes a battery 22 to provide power to the platform 12.

As will be discussed in greater detail, the detected events may include, for example, an automated application trigger such as a time-based trigger that is scheduled by a trigger logic module 10c based on a calendar entry that has only a colloquial name of the physical location (e.g., “Grandpa's place”) and is created before the mobile platform 12 enters the physical location. In such a case, the applications 16 could include an appointment calculation that creates the calendar entry based on user input, wherein the user may be unaware of the particular address of the physical location at the time of creating the calendar entry. Accordingly, the user might simply enter “Grandpa's place” as the colloquial name of the physical location. The illustrated logic architecture 10 also includes a database logic module 10d that is configured to associate the physical location with the colloquial name in one or more databases 24 for subsequent location requests by the user, others in the user's social circle, or others outside of the user's social circle, depending upon the circumstances. In this regard, the event logic module 10a may also include a translator 26 configured to translate the physical location data obtained from the databases 24 to a format (e.g., municipal address, latitude-longitude, coordinates relative to a fixed location) suitable for the application originating the location request.

The automated application trigger may also be generated by, for example, a calendar application that opens with the current location (unless the user changes the settings). In such a case, detection of the automated calendar application trigger could initiate the automated retrieval of the physical location of the mobile platform 12.

The detected events could also include a single-action request from a user interface (UI) 18 such as, for example, a touch screen component of the display device 20, or other UI component such as a mouse or keyboard. The single-action request, which could be obtained via a single button such as a “Here!” button, can enable the user to ascertain the current physical location of the mobile platform 12 without typing in the physical location or the colloquial name of the physical location. In such a case, the single-action request may cause the location logic module 10b to automatically determine the current physical location of the mobile platform 12, wherein the illustrated event logic module 10a provides that physical location to the display device 20 and/or applications 16. Additionally, the translator 26 may provide for re-formatting the physical location as appropriate.

Thus, the illustrated logic architecture 10 enables the elimination of the manual entry of a complete physical location both prior to and while the mobile platform 12 is at the physical location. Simply put, the user can take advantage of location based services without being required to determine location information such as municipal addresses or latitudinal-longitudinal coordinates, remember that location information, or enter that location information. As a result, the user's experience with regard to location based services can be significantly enhanced.

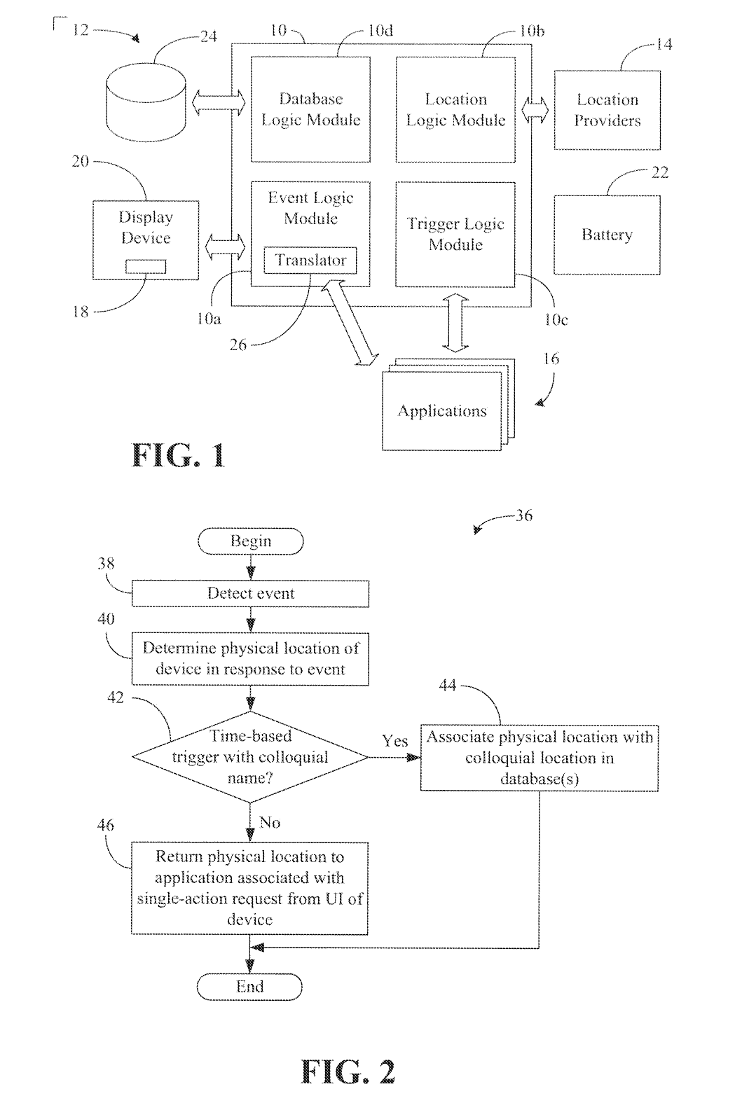

Turning now to FIG. 2, a method 36 of supporting location based services is shown. The method 36 may be implemented as a set of logic instructions stored in a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 36 may be written in any combination of one or more programming languages, including an object oriented programming language such as C++ or the like and conventional procedural programming languages, such as the “C” programming language or similar programming languages. Moreover, the method 36 could be implemented as the logic architecture 10 (FIG. 1) using any of the aforementioned circuit technologies.

Illustrated processing block 38 provides for detecting an event on a device such as a mobile platform, wherein a physical location of the device may be determined in response to the event at block 40. A determination may be made at block 42 as to whether the event is a time-based trigger that identifies a colloquial name for the physical location, wherein the time-based trigger has been scheduled based on a calendar entry that includes the colloquial name and was created before the device entered the physical location. If so, block 44 can associate the physical location with the colloquial location in one or more databases. Otherwise, it may be determined that the event is a single-action request from a UI of the device, wherein illustrated block 46 returns the physical location to the application associated with the single-action request. Thus, the illustrated method enables the elimination of the manual entry of a complete physical location both prior to and while the device is at the physical location, as already discussed. The order of operations shown may vary. For example, the determination of the type of event detected could be made prior to obtaining the physical location of the device.

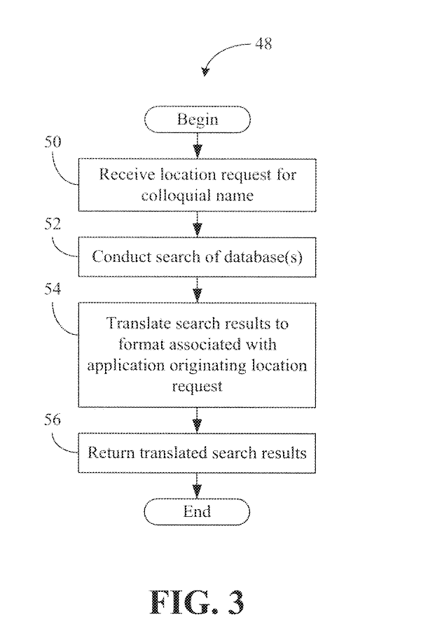

FIG. 3 shows a method 48 of processing a colloquial name request. The method 48 may be implemented as a set of logic instructions stored in a machine- or computer-readable storage medium such as RAM, ROM, PROM, flash memory, etc., in configurable logic such as, for example, PLAs, FPGAs, CPLDs, in fixed-functionality logic hardware using circuit technology such as, for example, ASIC, CMOS or TTL technology, or any combination thereof. Illustrated processing block 50 provides for receiving a location request for a colloquial name, wherein a search of one or more databases may be conducted at block 52. Block 54 may translate the search results to a format associated with the application originating the location request, wherein the translated search results can be returned at block 56.

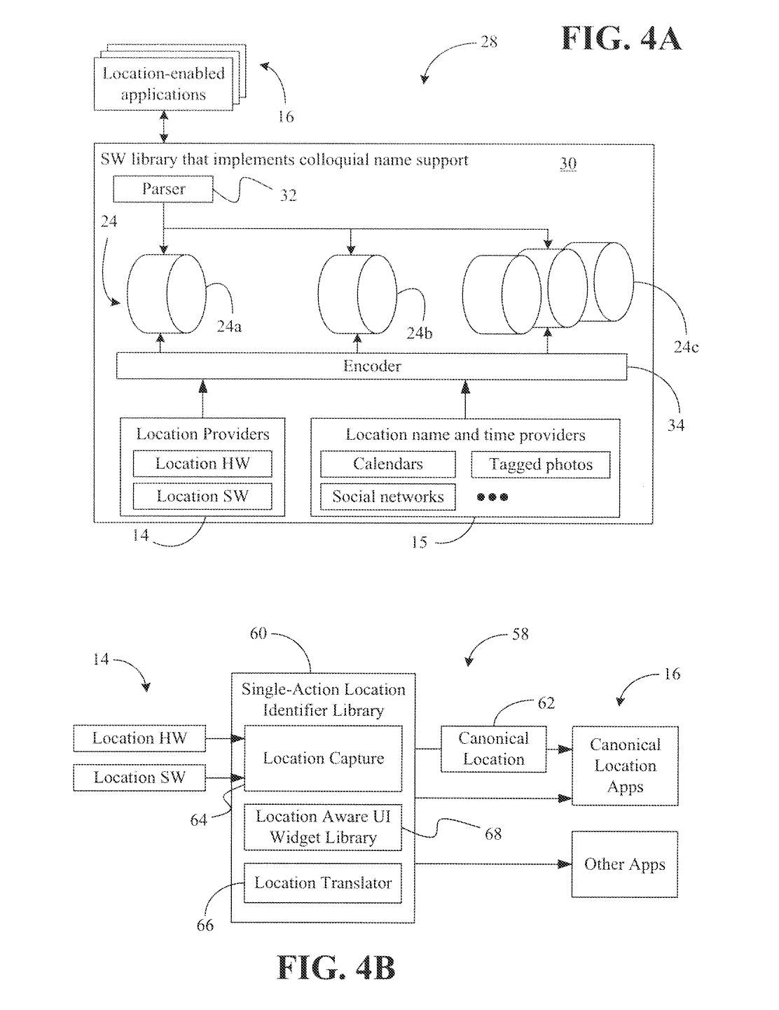

FIG. 4A shows a more detailed example of a system 28 in which colloquial naming of physical locations is supported. In the illustrated example, a software (SW) library 30 implements a parser 32 and an encoder 34, wherein the databases 24 (24a-24c) may include a private location database 24a, a social circle location database 24b, and one or more public location databases 24c. The private location database 24a may include physical location-name pairs that can be read or written by the user only, wherein each pair may have additional context information attached to it for disambiguation (e.g., distinguishing similar colloquial names, etc.). The context information may include visitation and/or use frequency, confidence level (e.g., probability), social graphs, previous activity, relationships, and other distinguishing factors. With specific regard to the confidence level, as the library 30 learns about the way a user selects colloquial names, the probability of a correct match may be increased. Until the probability reaches a certain threshold, the library 30 may prompt the user for verification/confirmation of matches (e.g., via pop-up map display or drop down menu of possible matches). The illustrated private location database 24a, which can be local or remote, can be accessed from multiple devices and enables the creation of personalized location names.

The social circle location database 24b may be shared among friends (e.g., on Facebook or other social networking site, or through an appropriate social collaboration application programming interface/API). The social circle location database 24b may aggregate the context information described above, and may otherwise be similar to the private location database 24a. Indeed, there may be scenarios in which the private location database 24a naturally migrates into the social circle location database 24b.

The public location databases 24c can include physical location-name pairs that have been collected and/or shared from private location databases, or have been created by other interested parties. The public location databases 24c may be seeded/populated by information from public resources such as OpenStreetMap or other geographic information system/GIS databases. The purpose of the public location databases 24c can be to percolate common place names into public availability. For example, large cities may have central sports venues that many people visit, wherein common “nicknames” for these venues can be made available to the public in order to facilitate navigation, tagging and other geo-location uses. Such databases may enable the user to input a colloquial name for a physical location that he or she hasn't visited yet. Similar to the aforementioned databases, the public location databases 24c may include additional context information for disambiguation, wherein the context information can include anonymous forms of visitation/use frequency, confidence level (e.g., probability), social graphs, previous activity, relationships and other distinguishing factors. The public location databases 24 may be maintained remotely and cached locally.

More particularly, the illustrated encoder 34 correlates physical location data with colloquially named places. For physical location data, the encoder 34 may communicate with device sensors (“Location HW”) and software logic (“Location SW”) that can support the sensors in making location determinations. For colloquially named place data, the encoder 34 may consult various data entries 15 having location names and time information, wherein the data entries 115 may include, but are not limited to, calendar entries, geo-tagged time-stamped photos, social networking updates, commercial event data such as concerts and public gatherings, and so forth. The illustrated encoder 34 creates physical location-name pairs and/or alters attached context information, in the databases 24.

The parser 32 may query the databases 24 and translate between different address and location formats upon request. For example, one or more of the applications 16 may have an input field that can accept any address, including colloquial names as already discussed, but may expect a particular type of location information. In this case, the parser 32 may identify a colloquial name in a location request from the application, consult with the databases 24, use the contextual information to determine a match, and convert the physical location associated with the name colloquial name to a format associated with the application that originated the location request. For example, the parser 32 might translate a location such as “Joy's fave bar” into a street address such as “1234 People St., Nicetown, Oreg. 97229” for navigation. Alternatively, the parser 32 can also generate latitude-longitude pairs if the navigation application so requests. Moreover, the illustrated parser 32 can operate in the reverse direction. For example, the parser 32 could display a colloquially named location for a photo that is tagged with lat-long <46, 21>, if those coordinates have a corresponding entry in the location databases 24.

By way of further example, a user might invite his or her family members to meet at Grandpa's place by composing a calendar invitation with “Grandpa's place” in the location field of the invitation. In such a case, a time-based trigger may also be scheduled to occur during the event in question. The invitees may receive the calendar invitation and accept the invitation if they are attending. At the scheduled time of the event, all invitees who have accepted the invitation may be physically present at the grandfather's house, carrying their smartphones or other location-aware devices such as smart tablets, navigation enabled vehicles, and so forth. Accordingly, the time-based triggers can be detected on the respective devices of the attendees, causing the collection of physical location data and a mapping between the colloquial name “Grandpa's place” and the current physical location. The physical location data can be maintained as a personal association, shared within a social circle (e.g., the family), or shared publicly, based on the privacy settings of the user.

From this point on, the participants who attended the event can use the phrase “Grandpa's place” in applications that request a physical location. For example, instead of entering a municipal address or having to geo-encode photos taken that evening, the attendees can simply tag the photos with “Grandpa's place” and the associated physical location may be substituted for the entered colloquial name. Thus, despite the user never having entered a street/municipal address or coordinates, the illustrated approach enables the photo to be automatically displayed, for example, in a geographical map at the precise location of the grandfather's house.

Turning now to FIG. 4B, a more detailed example of a system 58 that supports single-action requests for physical locations is shown. In general, a single-action location identifier (ID) library 60 may provide physical location information to applications 16 that may or may not be configured to accept a canonical location representation 62 of the location information. The canonical location representation 62 can be, for example, an extensible data structure that maintains different types of location information at their highest and most complete resolution. Thus, the representation 62 might be used to store the data collected from the location providers 14 on the system 58. For example, the user could be on the 10th floor of a budding in which each floor has a fingerprinted Wi-Fi infrastructure that enables the system 58 to determine what floor it is on. In such a case, the canonical location representation 62 may be a combination of a Wi-Fi assisted GPS fix, combined with the floor data.

More particularly, the location ID library 60 may include a location capture component 64 that communicates with the location providers 14 and captures the current physical location of the system 58 in the canonical location representation 62. Additionally, since the canonical location representation 62 may not be in a format supported by all of the applications 16, the illustrated library 60 also includes a location translator 66 that translates the canonical location representation 62 into common location formats. For example, if an application needs <lat, long> data, the translator 66 can translate the canonical location representation 62 into <lat, long> without changing the detail and resolution of the canonical location representation 62. The location ID library 60 may also include a location-aware UI widget library 68 that can invoke the location capture 64 and the location translator 66, wherein the UI widgets may use the location translator 66 to obtain physical locations in the correct format.

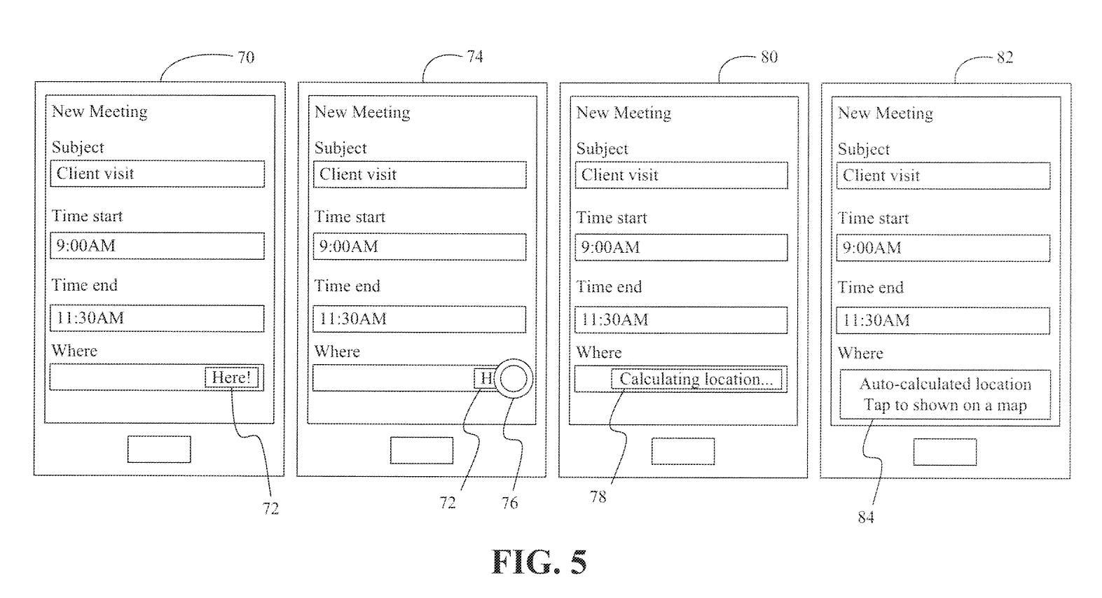

FIG. 5 shows a screenshot sequence of a single-action request UI. In the illustrated example a first state 70 of a calendar entry includes a single-action button 72 (e.g., labeled “Here!”) in a location field of the calendar entry. A second state 74 of the calendar entry demonstrates that the single-action button 72 may be selected via a single mouse click 76, wherein a status message 78 (e.g., “Calculating location . . . ”) can be displayed while the calendar entry is in a third state 80. A fourth state 82 of the calendar entry may include a confirmation message 84 (e.g., “Auto-calculated location Tap to shown on map”) in the location field, wherein the illustrated confirmation 84 is selectable to automatically show the current location on a map. Thus, the illustrated approach eliminates any need for the user to determine, remember or enter the current physical location, while still being able to use location based services.

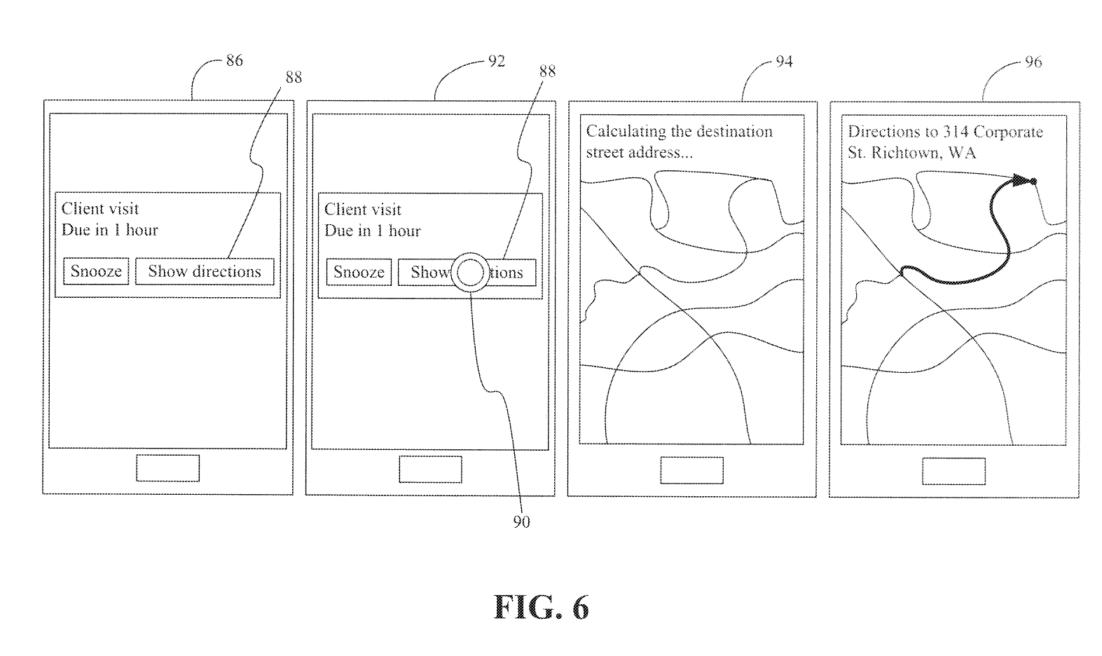

FIG. 6 shows a screenshot sequence in which a physical location previously retrieved/obtained in response to a single-action request is subsequently used in a UI associated with the calendar entry. In the illustrated example, a first state 86 of the UI includes a directions button 88, wherein the directions button 88 may be selected via a mouse click 90 in a second state 92 of the UI. A third state 94 of the UI may demonstrate that directions to the physical location can be calculated for display in a fourth state 96 of the UI. Thus, without the user typing an explicit address, the high resolution canonical location information attached to the event can be passed through a reverse-lookup process to obtain a street address that can be used by a mapping/navigation system.

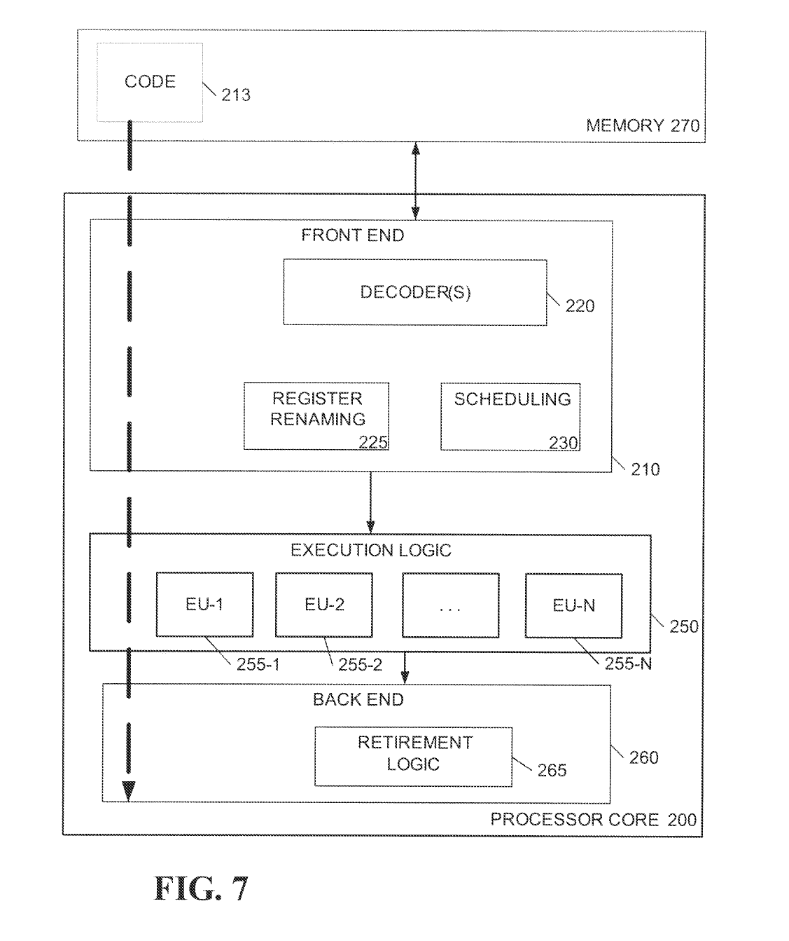

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the logic architecture 10 (FIG. 1), already discussed. The processor core 200 follows a program sequence of instructions indicated by the code 213. Each instruction may enter a from end portion 210 and be processed by one or more decoders 220. The decoder 220 may generate as its output a micro operation such as a fixed width micro operation predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 7, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

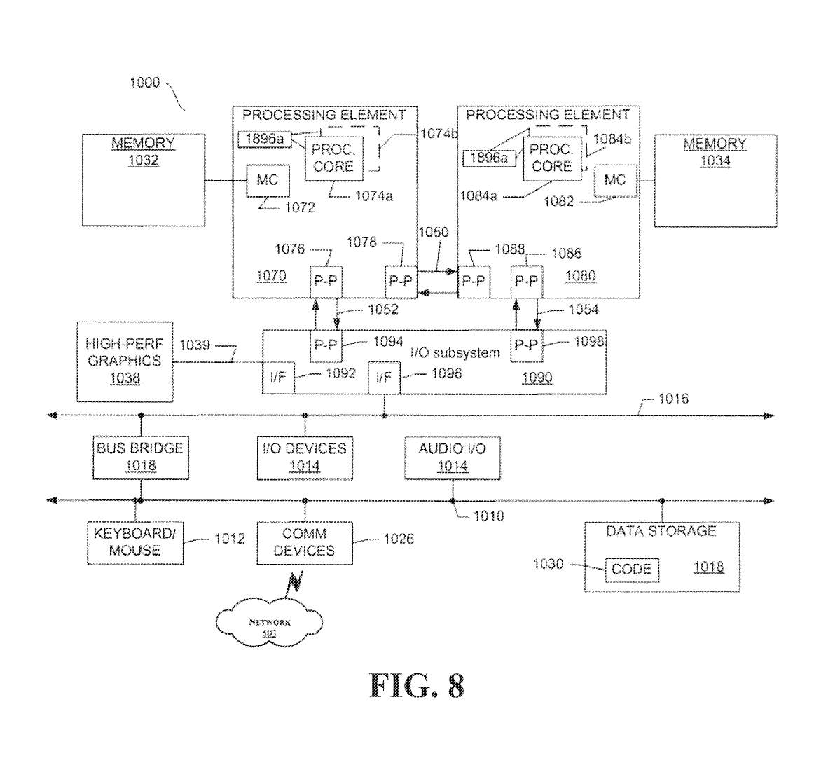

Referring now to FIG. 8, shown is a block diagram of a system embodiment 1000 in accordance with an embodiment of the present invention. Shown in FIG. 8 is a multiprocessor system 1000 that includes a first processing element 1070 and a second processing element 1080. While two processing elements 1070 and 1080 are shown, it is to be understood that an embodiment of system 1000 may also include only one such processing element.

System 1000 is illustrated as a point-to-point interconnect system, wherein the first processing element 1070 and second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 7.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC logic 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076, 1086 and 1084, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple graphics engine 1038 to I/O subsystem 1090. Alternately, a point-to-point interconnect 1039 may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the present invention is not so limited.

As shown in FIG. 8, various I/O devices 1014 such as the display device 20 (FIG. 1) may be coupled to the first bus 1016, along with a bus bridge 1018 which may couple the first bus 1016 to a second bus 1010. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network, not shown), and a data storage unit 1018 such as a disk drive or other mass storage device which may include code 1030, in one embodiment. The code 1030 may include instructions for performing embodiments of one or more of the methods described above. Thus, the illustrated code 1030 may implement the logic architecture 10 (FIG. 1) and could be similar to the code 213 (FIG. 7), already discussed. Further, an audio I/O 1024 may be coupled to second bus 1020.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

Embodiments may include an apparatus having an event logic module to detect an event, and a location logic module to determine a physical location of a mobile platform in response to the event. The event may be one of an automated application trigger and a single-action request from a user interface of the mobile platform.

Additionally, the automated application trigger may be a time-based trigger that identifies a colloquial name for the physical location, wherein the apparatus further includes a trigger logic module to schedule the time-based trigger based on a calendar entry that is to include the colloquial name and is to be created before the mobile platform enters the physical location.

Additionally, the apparatus may further include a database logic module to associate the physical location with the colloquial name in a database.

Moreover, the database logic module may associate the physical location with the colloquial name in one or more of a private database, a social circle database, and a public database.

In addition, the database logic module can attach one or more of a probability and context information to the physical location in the database.

In addition, the database logic module may receive a location request that includes the colloquial name, conduct a search of the database for the colloquial name, and return a result of the search.

Moreover, the apparatus may further include a translation logic module to translate the result to a format associated with an application that originated the location request.

Additionally, the location logic module of any one of the aforementioned apparatus embodiments may use one or more of a Global Positioning System (GPS) sensor and a Wi-Fi component on the mobile platform to determine the physical location.

Embodiments may also include at least one computer-readable medium having one or more instructions that when executed on a processor, configure the processor to detect an event and determine a physical location of a mobile platform in response to the event. The event may be one of an automated application trigger and a single-action request from a user interface of the mobile platform.

Additionally, the automated application trigger may include a time-based trigger that identifies a colloquial name for the physical location, and wherein when executed the one or more instructions configure a processor to schedule the time-based trigger based on a calendar entry that is to include the colloquial name and is to be created before the mobile platform enters the physical location.

Additionally, when executed the one or more instructions can configure a processor to associate the physical location with the colloquial name in a database.

Moreover, the physical location may be associated with the colloquial name in one or more of a private database, a social circle database, and a public database.

In addition, when executed the one or more instructions may configure a processor to attach one or more of a probability and context information to the physical location in the database.

In addition, when executed the one or more instructions can configure a processor to receive a location request that includes the colloquial name, conduct a search of the database for the colloquial name, and return a result of the search.

Moreover, when executed, the one or more instructions may configure a processor to translate the result to a format associated with an application that originated the location request.

Additionally, the one or more instructions of any one of the aforementioned computer-readable medium embodiments, when executed, can configure a processor to use one or more of a Global Positioning System (UPS) sensor and a Wi-Fi component on the mobile platform to determine the physical location.

Embodiments may also include a mobile platform having a battery to provide power to the platform, a sensor, an event logic module to detect an event, and a location logic module to use the sensor to determine a physical location of the mobile platform in response to the event. The event may be one of a time-based trigger that identifies a colloquial name for the physical location and a single-action request from a user interface of the mobile platform.

Additionally, the platform may further include a trigger logic module to schedule the time-based trigger based on a calendar entry that is to include the colloquial name and is to be created before the mobile platform enters the physical location.

Additionally, the platform can further include a database logic module to associate the physical location with the colloquial name in a database.

Moreover, the database logic module may associate the physical location with the colloquial name in one or more of a private database, a social circle database, and a public database.

In addition, the database logic module may attach one or more of a probability and context information to the physical location in the database.

In addition, the database logic module may receive a location request that includes the colloquial name, conduct a search of the database for the colloquial name, and return a result of the search.

Moreover, the platform can further include a translation logic module to translate the result to a format associated with an application that originated the location request.

Additionally, the sensor of any one of the aforementioned mobile platform of any one of claims 5 to 11, may include one or more of a Global Positioning System (GPS) sensor and a Wi-Fi component.

Embodiments can also include a method of supporting location based services in which a time-based trigger is scheduled based on a calendar entry. The time-based trigger can be detected, wherein the method may provide for determining the physical location of a mobile platform in response to the time-based trigger. In one example, the calendar entry identifies a colloquial name and is created before the mobile platform enters the physical location. Moreover, the physical location can be associated with the colloquial name in a database. Additionally, the method may involve receiving a location request that includes the colloquial name, conducting a search of the database for the colloquial name, and translating a result of the search to a format associated with an application that originated the location request. The method may also provide for returning the result of the search.

Additionally, the physical location may be associated with the colloquial name in one or more of a private database, a social circle database, and a public database.

Additionally, the method may further include attaching one or more of a probability and context information to the physical location in the database.

Moreover, any one of the aforementioned method embodiments may use one or more of a Global Positioning System (GPS) sensor and a Wi-Fi component on the mobile platform to determine the physical location.

Embodiments may also include a method of supporting location based services, wherein the method involves receiving a location request that includes a colloquial name. A search of a database may be conducted for the colloquial name, wherein a result of the search can be translated to a format associated with an application that originated the location request. The method may also provide for returning the result of the search, wherein the result includes a physical location associated with the colloquial name.

Additionally, the search may be conducted with respect to one or more of a private database, a social circle database, and a public database.

Additionally, the method can further include scheduling a time-based trigger based on a calendar entry, detecting the time-based trigger, wherein the calendar entry identifies the colloquial name and is created before the mobile platform enters the physical location, and associating the physical location with the colloquial name in the database.

Techniques described herein may therefore provide a mechanism to use colloquial location names as mappable addresses, as well as to seamlessly attach location information to data entries. Accordingly, users may not be inconvenienced by having to manually determine, remember, or enter addresses and/or coordinates into location based applications.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing, system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1.-31. (canceled)

32. A method of supporting location based services comprising:
scheduling a time-based trigger based on a calendar entry;
detecting the time-based trigger;
determining a physical location of a mobile platform in response to the time-based trigger, wherein the calendar entry identifies a colloquial name and is created before the mobile platform enters the physical location; and
associating the physical location with the colloquial name in a database;
receiving a location request that includes the colloquial name;
conducting a search of the database for the colloquial name;
translating a result of the search to a format associated with an application that originated the location request; and
returning the result of the search.

33. The method of claim 32, wherein the physical location is associated with the colloquial name in one or more of a private database, a social circle database, and a public database.

34. The method of claim 32, further including attaching one or more of a probability and context information to the physical location in the database.

35. The method of claim 32, wherein one or more of a Global Positioning System (GPS) sensor and a Wi-Fi component on the mobile platform is used to determine the physical location.

36. A mobile platform comprising:
a battery to provide power to the platform;
a sensor;
an event logic module to detect an event; and
a location logic module to use the sensor to determine a physical location of the mobile platform in response to the event, wherein the event is to be one of a time-based trigger that identifies a colloquial name for the physical location and a single-action request from a user interface of the mobile platform.

37. The mobile platform of claim 36, further including a trigger logic module to schedule the time-based trigger based on a calendar entry that is to include the colloquial name and is to be created before the mobile platform enters the physical location.

38. The mobile platform of claim 36, further including a database logic module to associate the physical location with the colloquial name in a database.

39. The mobile platform of claim 38, wherein the database logic module is to associate the physical location with the colloquial name in one or more of a private database, a social circle database, and a public database.

40. The mobile platform of claim 38, wherein the database logic module is to attach one or more of a probability and context information to the physical location in the database.

41. The mobile platform of claim 38, wherein the database logic module is to receive a location request that includes the colloquial name, conduct a search of the database for the colloquial name, and return a result of the search.

42. The mobile platform of claim 41, further including a translation logic module to translate the result to a format associated with an application that originated the location request.

43. The mobile platform of claim 36, wherein the sensor includes one or more of a Global Positioning System (GPS) sensor and a Wi-Fi component.

44. An apparatus comprising:
an event logic module to detect an event; and
a location logic module determine a physical location of a mobile platform in response to the event, wherein the event is to be one of an automated application trigger and a single-action request from a user interface of the mobile platform.

45. The apparatus of claim 44, wherein the automated application trigger is to be a time-based trigger that identifies a colloquial name for the physical location, and wherein the apparatus further includes a trigger logic module to schedule the time-based trigger based on a calendar entry that is to include the colloquial name and is to be created before the mobile platform enters the physical location.

46. The apparatus of claim 44, further including a database logic module to associate the physical location with the colloquial name in a database.

47. The apparatus of claim 46, wherein the database logic module is to associate the physical location with the colloquial name in one or more of a private database, a social circle database, and a public database.

48. The apparatus of claim 46, wherein the database logic module is to attach one or more of a probability and context information to the physical location in the database.

49. The apparatus of claim 46, wherein the database logic module is to receive a location request that includes the colloquial name, conduct a search of the database for the colloquial name, and return a result of the search.

50. The apparatus of claim 49, further including a translation logic module to translate the result to a format associated with an application that originated the location request.

51. The apparatus of claim 44, wherein the location logic module is to use one or more of a Global Positioning System (GPS) sensor and a Wi-Fi component on the mobile platform to determine the physical location.

52. At least one computer-readable medium comprising one or more instructions that when executed on a processor configure the processor to:
detect an event; and
determine a physical location of a mobile platform in response to the event, wherein the event is to be one of an automated application trigger and a single-action request from a user interface of the mobile platform.

53. The at least one medium of claim 52, wherein the automated application trigger is to include a time-based trigger that identifies a colloquial name for the physical location, and wherein when executed the one or more instructions configure a processor to schedule the time-based trigger based on a calendar entry that is to include the colloquial name and is to be created before the mobile platform enters the physical location.

54. The at least one medium of claim 52, wherein when executed the one or more instructions configure a processor to associate the physical location with the colloquial name in a database.

55. The at least one medium of claim 54, wherein the physical location is to be associated with the colloquial name in one or more of a private database, a social circle database, and a public database.

56. The at least one medium of claim 54, wherein when executed the one or more instructions configure a processor to attach one or more of a probability and context information to the physical location in the database.

57. The at least one medium of claim 54, wherein when executed, the one or more instructions configure a processor to:
receive a location request that includes the colloquial name;
conduct a search of the database for the colloquial name; and
return a result of the search.

58. The at least one medium of claim 57, wherein when executed, the one or more instructions configure a processor to translate the result to a format associated with an application that originated the location request.

59. The at least one medium of claim 52, wherein when executed, the one or more instructions configure a processor to use one or more of a Global Positioning System (GPS) sensor and a Wi-Fi component on the mobile platform to determine the physical location.

60. A method comprising:
receiving a location request that includes a colloquial name;
conducting a search of a database for the colloquial name;
translating a result of the search to a format associated with an application that originated the location request; and
returning the result of the search, wherein the result includes a physical location associated with the colloquial name.

61. The method of claim 60, wherein the search is conducted with respect to one or more of a private database, a social circle database, and a public database.

62. The method of claim 60, further including:
scheduling a time-based trigger based on a calendar entry;
detecting the time-based trigger;
determining a physical location of a mobile platform in response to the time-based trigger, wherein the calendar entry identifies the colloquial name and is created before the mobile platform enters the physical location; and
associating the physical location with the colloquial name in the database.
